(19) United States
(12) Patent Application Publication
(10) Pub. No.: US 2012/0275863 A1
(43) Pub. Date: Nov. 1, 2012

(54) METHOD AND APPARATUS TO MANAGE WATER FLOW

(76) Inventor: JACK GOLDWASSER, Grants Pass, OR (US)

(21) Appl. No.: 13/098,081

(22) Filed: Apr. 29, 2011

(51) Int. Cl. E02B 7/26; B23P 19/04

(52) U.S. Cl. 405/103; 29/428

(57) ABSTRACT

A method and apparatus for managing water flow are provided. A frame positions two gate blades, wherein each blade movable along a single axis, preferably a vertical axis. A lower blade is typically positioned below an upper blade. The upper blade may move independently of the lower blade and may be alternately coupled and decoupled to the lower blade. A coupling module enables the selectable and alternating coupling and decoupling of the upper blade and the lower blade. The coupling module may the spring-loaded rod having a first position and a second position, wherein the spring-loaded rod couples the upper blade and the lower blade in the first position and the spring-loaded catch decouples the upper blade and the lower blade in the second position.

### FIELD OF THE INVENTION

The present invention relates to flood control and water management methods and devices. More particularly, the present invention relates to methods and apparatuses for selectably controlling water flow.

### BACKGROUND OF THE INVENTION

Prior art devices have been developed to control water in irrigation supply canals, flood control networks, and other water channels. Such devices are useful to manage water resources effectively and to limit the damage of flooding.

An example of such a prior art device used to maintain a constant or predetermined water level in an irrigation ditch gate as found in U.S. Pat. No. 7,114,878 (hereinafter “'878”). The '878 disclosure attempts to describe an irrigation gate system which can be easily and quickly adjusted electronically to achieve a desired flow through an irrigation gate system. The disclosure of '878 further discusses a method of managing a gate within an irrigation system with an intent to control upstream water levels and respond to other conditions, such as downstream flow.

One disadvantage of the system presented in the '878 invention patent is that it includes two sidewalls that each swing about separate vertical hinge mechanisms. This disadvantage is especially pronounced when attempting to stop fluid flow entirely by swinging the sidewalls together against the direction of momentum of a flow of water.

A further disadvantage of the system disclosed in the '878 patent is that each side gate requires a separate drive train.

It is, therefore, desirable to provide a water gate system which does not require individuated vertical hinge mechanisms for all movements of the gate or gates of an gate assembly.

### SUMMARY OF THE INVENTION

It is an object of the present invention to obviate or mitigate the disadvantages of the prior art by providing a water control gate system having two vertically positionable gate blades that selectably limit water flow. It is a further object of the present invention to provide a water control gate which can be applied to selectably couple and decouple two gate blades. Toward these and other objects that are made obvious in light of the disclosure, a method and system are provided for vertically positioning a two gate blades that are selectably coupled for movement in combination.

In a first aspect, an upper blade may move vertically and without effecting the position of the lower blade. In a second aspect, the upper blade is coupled with the lower blade and the two gate blades move together in combination. In a first preferred embodiment, a single drive chain is provided that moves the gate blades in combination when these gates are in a coupled state.

In a third optional aspect, a coupling mechanism presses against the lower blade and is constrained from moving upwards in relation to the lower blade when the upper blade is lowered to a first position; whereby the lower blade is raised as the upper blade is raised. The coupling mechanism may be lowered from the first position to a second position, whereupon the coupling mechanism is released from movement constraint by a release feature of the lower blade, and the upper blade and lower blade are decoupled. The upper blade may then be raised to a third position, whereupon the coupling mechanism is reset by a reset feature, whereby the coupling mechanism is armed to couple the lower blade with the upper blade when the upper blade is again lowered into the first position.

In a fourth optional aspect, the coupling mechanism includes a bar or catch feature that is configured to press toward the lower blade as the upper blade is lowered into the catch position. The bar or catch feature is further configured to be positioned away from the lower blade when the upper blade is moved below the catch position and past a release position. The bar or catch feature is yet further configured to be reset to press toward lower blade when the upper blade is raised relative to the lower blade from the release position and to a reset position.

Other aspects and features of the present invention will become apparent to those ordinarily skilled in the art upon review of the following description of specific embodiments of the invention in conjunction with the accompanying figures.

### INCORPORATION BY REFERENCE

All publications mentioned herein are incorporated herein by reference to disclose and describe the methods and/or materials in connection with which the publications are cited. All publications, patents, and patent applications mentioned in this specification are herein incorporated by reference in their entirety and for all purposes to the same extent as if each individual publication, patent, or patent application was specifically and individually indicated to be incorporated by reference.

Such incorporations include U.S. Pat. No. 7,114,878 (inventors Craig, et al.; issued Oct. 3, 2006) titled “Irrigation gate system”; U.S. Pat. No. 7,255,128 (inventors: Sandhu, et al.; issued on Aug. 14, 2007) titled “System and method for detecting flow in a mass flow controller”; U.S. Pat. No. 5,967,697 (inventors: Larsen, et al.; issued on Oct. 19, 1999), titled “Flood control gate safety device”; U.S. Pat. No. 4,877,352 (inventors: Tuttle, et al.; issued on Oct. 31, 1989) titled “Method and apparatus for control of an upstream water level”; U.S. Pat. No. 3,952,522 (inventor Shettel, R.; issued on Apr. 27, 1976) titled “Irrigation systems automation”; U.S. Pat. No. 3,354,655 (inventor: Armond, Charles V.; issued on Nov. 26, 1967), titled “Automatically operated door for water control”; U.S. Pat. No. 2,979,909 (inventor: Stanley, Broadbent; issued on Apr. 18, 1961), titled “Sluice Gate”; U.S. Pat. No. 2,361,439 (inventor: Samuel, Weiss; issued on Oct. 31, 1944), titled Torque control switch; U.S. Pat. No. 2,041,576 (inventor: Alfred, Suksdorf; issued on May 19, 1936), titled “Control system”; and U.S. patent application Ser. No. 13/021,750 (inventor: Goldwasser, Jack; filed on Feb. 5, 2011) titled “METHOD AND APPARATUS FOR SELECTIVE MECHANICAL ENTRAINMENT”.

The publications discussed or mentioned herein are provided solely for their disclosure prior to the filing date of the present application. Nothing herein is to be construed as an admission that the present invention is not entitled to antedate such publication by virtue of prior invention. Furthermore, the dates of publication provided herein may differ from the actual publication dates which may need to be independently confirmed.

### BRIEF DESCRIPTION OF THE FIGURES

These, and further features of various aspects of the present invention, may be better understood with reference to the accompanying specification, wherein:

FIG. 1A is an upper left isometric view of a split gate in an unlatched condition, wherein an upper blade and a lower blade are decoupled and not entrained;

FIG. 1B is an upper right isometric view of the split gate of FIG. 1A in the unlatched condition and the upper blade is not entrained with the lower blade;

FIG. 1C is a detailed view of an upper area of the upper blade and partial view of the lift stem and frame of FIG. 1A, showing both a right latch arm and a left latch arm of a latch rod of the upper blade in an armed state and wherein neither latch arm is engaged with the lower blade;

FIG. 1D is a detailed right partial isometric view of the gate frame and an upper area of the lower blade of FIG. 1A in a decoupled state, wherein the lower blade is not entrained with the upper blade;

FIG. 2A is a front view the split gate of FIG. 1A, wherein the upper blade and the lower blade are not entrained and the latch arms of FIG. 1C are in the armed state;

FIG. 2B is a side view of the right latch of FIG. 1C of the upper blade of FIG. 1A, wherein the right latch arm is in the armed state and is not engaged with the lower blade of FIG. 1A;

FIG. 2C is, in comparison with the side view of FIG. 2B, a reverse view of the right latch of FIG. 1C of the upper blade of FIG. 1A, wherein the right latch arm is in the armed state and is not engaged with the lower blade of FIG. 1A;

FIG. 3A is an upper left isometric view of the split gate of FIG. 1A in a latched condition, wherein the upper blade and the lower blade are entrained by the latch rod of FIG. 1C and the lower blade is shown at a lowest vertical position, and a proximity sensor location is indicated;

FIG. 3B is an upper right isometric view of the split gate of FIG. 1A in a latched condition, wherein the upper blade and the lower blade are entrained by the latch rod of FIG. 1C and the lower blade is shown at a lowest vertical position, and wherein the left latch arm location is indicated;

FIG. 4A is an upper left isometric view of the upper blade and the lower blade of FIG. 1A in the latched condition and wherein the upper blade is positioned by rotation of the stem in engagement with the upper blade into a mid-range vertical position within the gate frame;

FIG. 4B is an upper right isometric view of the upper blade and the lower blade of FIG. 1A in the latched condition and wherein the upper blade is positioned by rotation of the stem in engagement with the upper blade into a mid-range vertical position within the gate frame;

Frame 4C is a detailed view of the right latch assembly wherein the right latch arm is in the armed state and is engaged with the right catch of the lower blade, causing the lower blade to move vertically with the upper blade;

FIG. 5A is a detailed view of an installation of a proximity sensor as positioned within the left side of the gate frame of FIG. 1A at a moment when the moveable lower blade is positioned to be sensed by the proximity sensor;

FIG. 5B is a detailed view of a left latch mechanism of the gate of FIG. 1A and showing a proximity pin of the proximity sensor of FIG. 5A and further showing the left latch arm engaged with the left catch of the lower blade;

FIG. 6A is a front view of the lower blade entrained with the upper blade of FIG. 1A and wherein the lower blade is positioned at a lowest vertical position;

FIG. 6B is a detailed sectional side view of the right latch mechanism of the gate of FIG. 1A wherein the right latch arm of the latch rod is engaged with the right catch of the lower blade;

FIG. 7A is a detailed isometric view of the upper blade and the lower blade of FIG. 1A wherein the right latch arm is in a released state and constrained from further upward rotation by a right latch pin;

FIG. 7B is a detailed side view of the upper blade and the lower blade of FIG. 1A showing the right latch arm placed into the released state by downward motion of the upper blade, wherein the lower blade is at a lowest position and the upper blade is driven further downward, whereby a lower right cam lobe of the lower blade forces the right latch arm from the armed state and into the release position and against the right latch pin;

FIG. 8A is an upper left isometric view of a split gate of FIG. 1A in an unlatched condition, and wherein the left latch arm is forced from a release position and returned to the armed state, and indicating a left side detail of FIG. 8C;

FIG. 8B is an upper right isometric view of a split gate of FIG. 1A in an unlatched condition, and wherein the right latch arm is forced from a release position and returned to the armed state, and indicating a right side detail of FIG. 8D;

FIG. 8C is a detailed left side isometric view of the split gate of FIG. 8A;

FIG. 8D is a detailed right side isometric view of the split gate of FIG. 8A;

FIG. 9A is a side view of the split gate of FIG. 1A wherein the latch rod is reset into the armed state;

FIG. 9B is a front view of the split gate of FIG. 1A wherein the latch rod is reset into the armed state;

FIG. 9C is a side view of a detail of the split gate of FIG. 1A, wherein the left latch arm is shown to be rest from the release position and into the armed state by contact against the left reset plate of the gate frame as the upper blade is driven vertically upward and against the left reset plate;

FIG. 10A is an upper right isometric view of the split gate of FIG. 1A wherein a detail view of FIG. 10B is indicated;

FIG. 10B is an isometric view of a detail of the stem and the lift nut sprocket assembly of the split gate of FIG. 1A;

FIG. 11A is an upper right isometric view of an alternate split gate having a pair of threaded stems engaging with an upper blade and wherein a detail view of FIG. 11B is indicated; and

FIG. 11B is an isometric view of a detail of the pair of stems and actuator of the alternate split gate of FIG. 11A.

### DETAILED DESCRIPTION

Generally, the present invention provides a method and device for providing a gate system, which can be applied to adjustably impede or enable water flow.

It is to be understood that the present invention is not limited to particular aspects of the present invention described, as such may, of course, vary. It is also to be understood that the terminology used herein is for the purpose of describing particular aspects only, and is not intended to be limiting, since the scope of the present invention will be limited only by the appended claims.

In the following detailed description of the invention, reference is made to the accompanying drawings which form a part hereof, and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention.

Methods recited herein may be carried out in any order of the recited events which is logically possible, as well as the recited order of events.

Where a range of values is provided herein, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

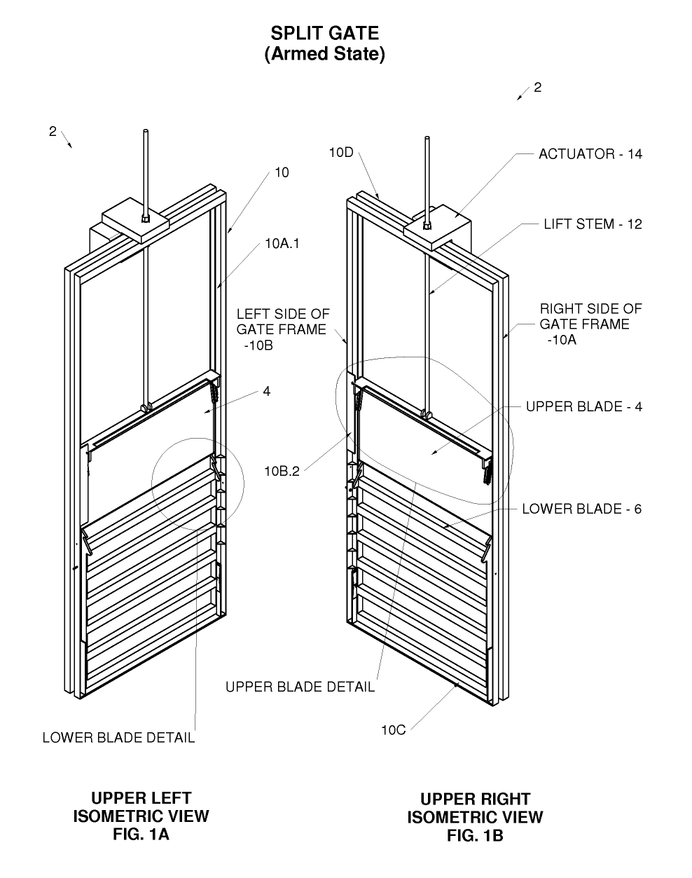

Referring now generally to Figures and particularly to FIG. 1A through FIG. 1D, FIG. 1A is an upper left isometric view of a split gate 2 in an unlatched condition, wherein an upper blade 4 and a lower blade 6 are decoupled and a latch rod 8 of the upper blade 4 is armed to entrain the lower blade 6 when the upper blade 4 is lowered downward along within the gate frame 10 sufficiently toward the lower blade 6.

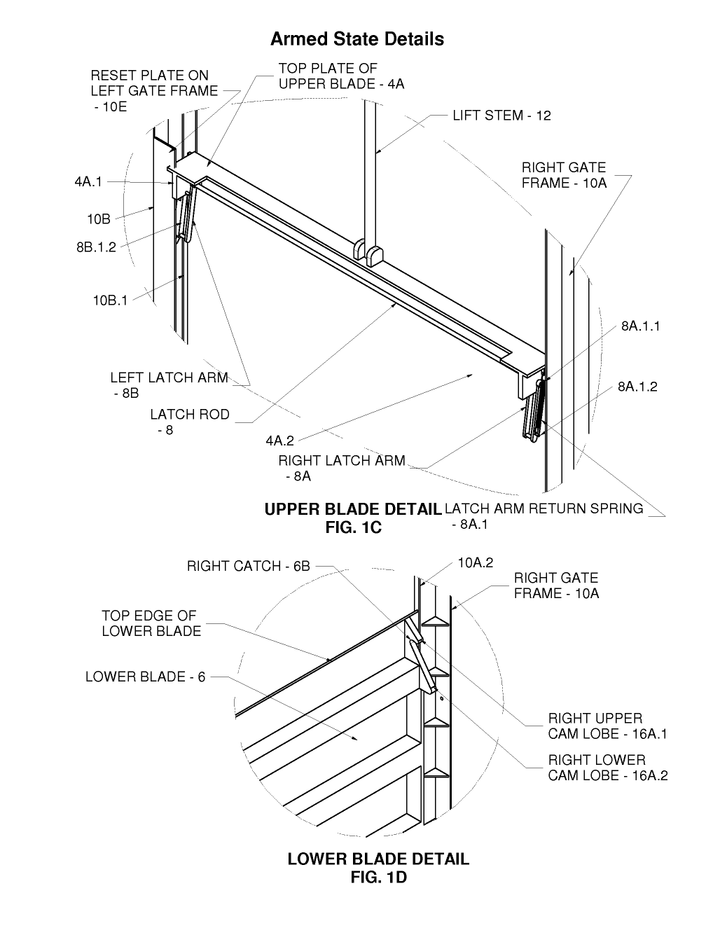

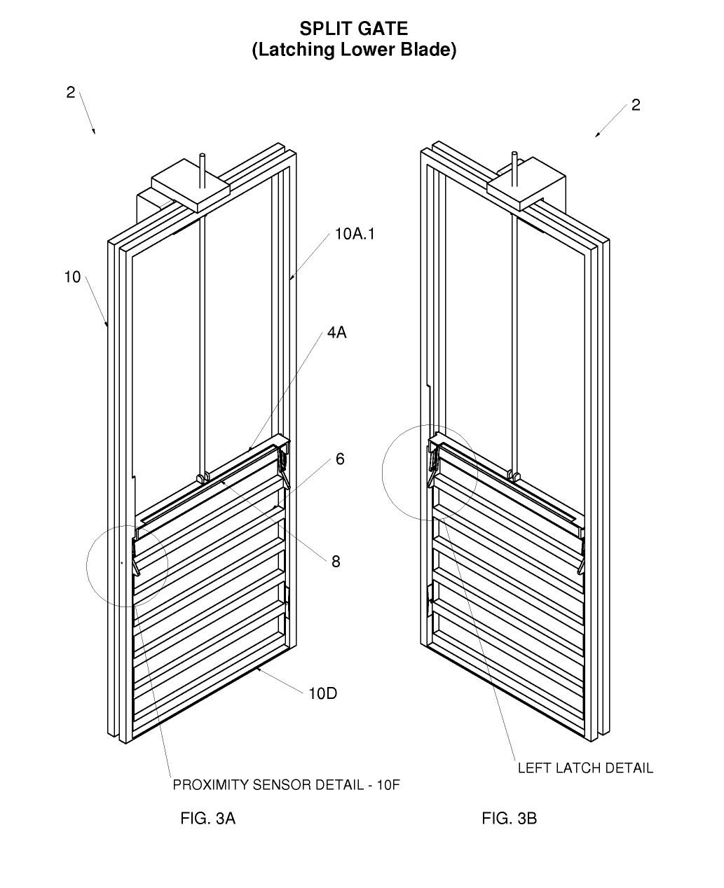

The upper blade 4 and the lower blade 6 are both supported and maintained in a vertical orientation within the frame 10 by a right frame bar 10A and a left frame bar 10B. As shown in FIG. 1A and FIG. iD, a first right slot 10A.1 of the right frame bar 10A and a first left slot 10B.1 of the left gate bar 10B captures the upper blade 4 and substantively restricts travel of the upper blade 4 to vertical movement along the Y-axis. As shown in FIGS. 4A and 4B, a second right slot 10A.2 of the right frame bar 10A and a second left slot 10B.2 of the left gate bar 10B captures the lower blade 6 and substantively restricts travel of the lower blade 6 to vertical movement upwards or alternately downwards along a Y-axis, as indicated in FIG. 2A and FIG. 2B.

A bottom frame bar 100 limits the vertical travel of both the upper blade 4 and the lower blade 6 in the downward vertical direction. A top frame bar 10D limits the vertical travel of both the upper blade 4 and the lower blade 6 in the upward vertical direction.

A threaded lead screw 12, or lift stem 12, is rotatably coupled with the upper blade 4 and the lift stem 12 alternately raises or lowers the upper blade 4 as the stem 12 is rotated about a vertical Y-axis. A motorized actuator 14 is provided that provides mechanically torque to alternately rotate the stem 12 either clockwise or counter-clockwise about the vertical axis, and thereby cause the upper blade 4 up or down along the vertical Y-axis.

The gate frame 10 may be positioned in or along an irrigation canal or water containing or water managing system having a volume of water (not shown) wherein the upper blade 4 may be positioned by rotation of the stem 12 to (a.) be lowered and to allow water to flow over a top plate 4A of the upper blade 4; or (b.) alternately be raised vertically within the gate frame 10 to impede water flow over the top plate 4A of the upper blade 4. In addition, the lower blade 6 may alternately or additionally be entrained with the upper blade 4 and be raised to enable water flow beneath a bottom edge 6A of the lower blade 6.

FIG. 1B is an upper right isometric view of the split gate 2 in the unlatched condition of FIG. 1A.

FIG. 1C is a detail view of an upper area 4B of the upper blade 4 and partial view of the lift stem 12 and partial view of the frame 10 with the latch rod 8 in the unlatched condition. The latch rod 8 having a right latch arm 8A and a left latch arm 8B is rotatably coupled with the upper blade 4. The latch rod 8 simultaneously extends through both a right flange 4A.1 and a left flange 4A.2 of the upper blade top plate 4A; the extension of the rod through each top plate flanges 4A.1 & 4A.2 allows the latch rod 8 to rotate in relation to the upper blade 4.

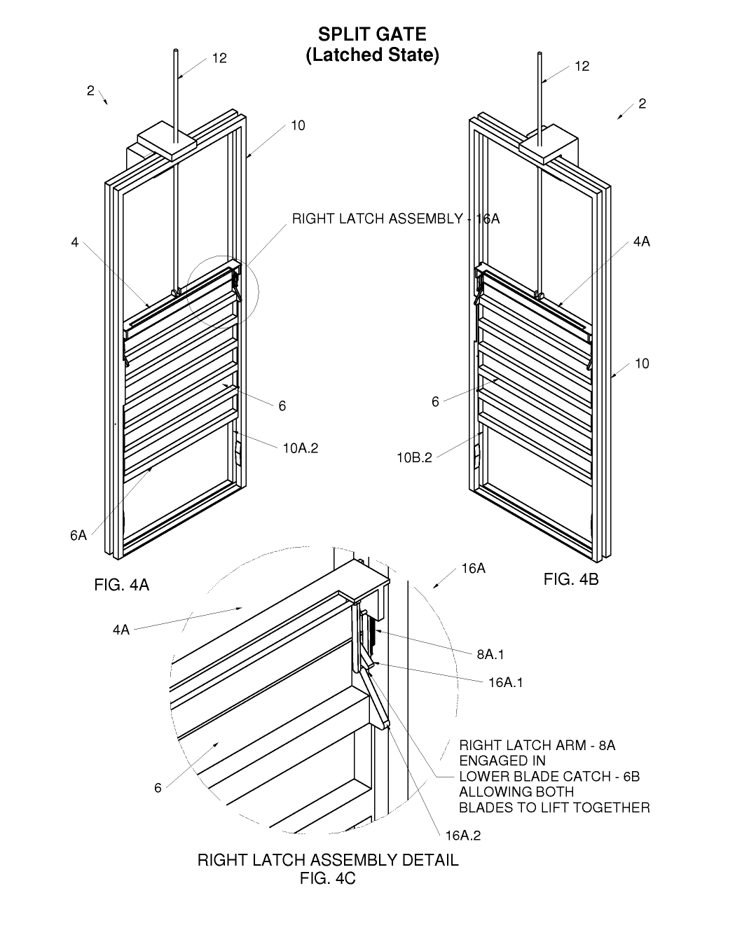

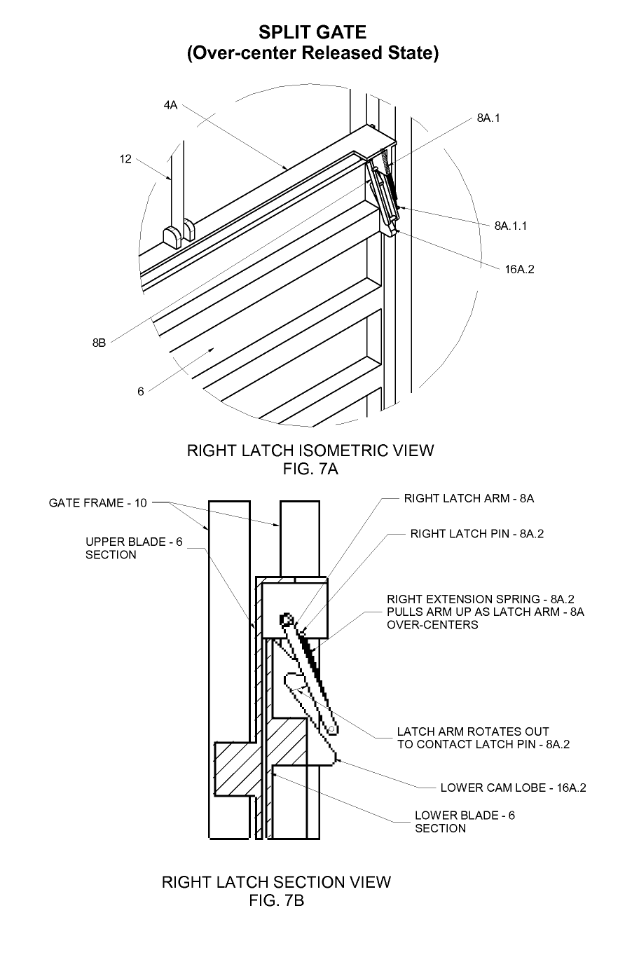

The latch rod 8 is shown in FIG. 1C in an armed condition and is enabled by a right arm return spring 8A.1 and, as shown in FIG. 5B, a left arm return spring 8B.1 that, in the armed state, each drive towards the lower blade 6 and to enable entrainment of the lower blade 6 with the upper blade 4 by means of engagement of the latch rod 8 with a right catch 6B and a left catch 6C of the lower blade 6, as shown respectively in FIG. 1D and FIG. 8C. The right arm return spring 8A.1 is attached both (a.) at a right spring attach end 8A.1.1 to the upper blade 4; and (b.) at a right spring arm attach end 8A.1.2 to the right latch arm 8A. The left arm return spring 8B.1 is attached both (a.) at a left spring attach end 8B.1.1 to the upper blade 4; and (b.) at a left spring arm attach end 8B.1.2 to the left latch arm 8B.

A left reset plate 10E of the gate frame 8 is positioned to rotate the left latch arm 8B, and thus the entire latch rod 8, from a release position and to reset the latch rod 8 from the release position and into the armed state, i.e., the armed condition. When the latch rod 8 is in the armed condition, both the left latch arm return spring 8B.1 and the right latch arm return spring 8A.1 pull the latch rod 8 to engage with the lower blade 6 and to enable entrainment of the lower blade 6 with the upper blade 4.

When the latch rod 8 is in the release condition, the right latch arm return spring 8A.1 and the left latch arm return spring 8B.1 both provide tension force to the latch rod 8 to maintain the latch rod 8 in a position that extends the latch rod 8 away from the lower blade 6, whereby the lower blade 6 is released and the latch rod 8 does not engage with the lower blade 6. The upper blade 4 and the lower blade 6 are thus not entrained and are decoupled when the right latch arm 8A and the left latch arm 8B are respectively release positions.

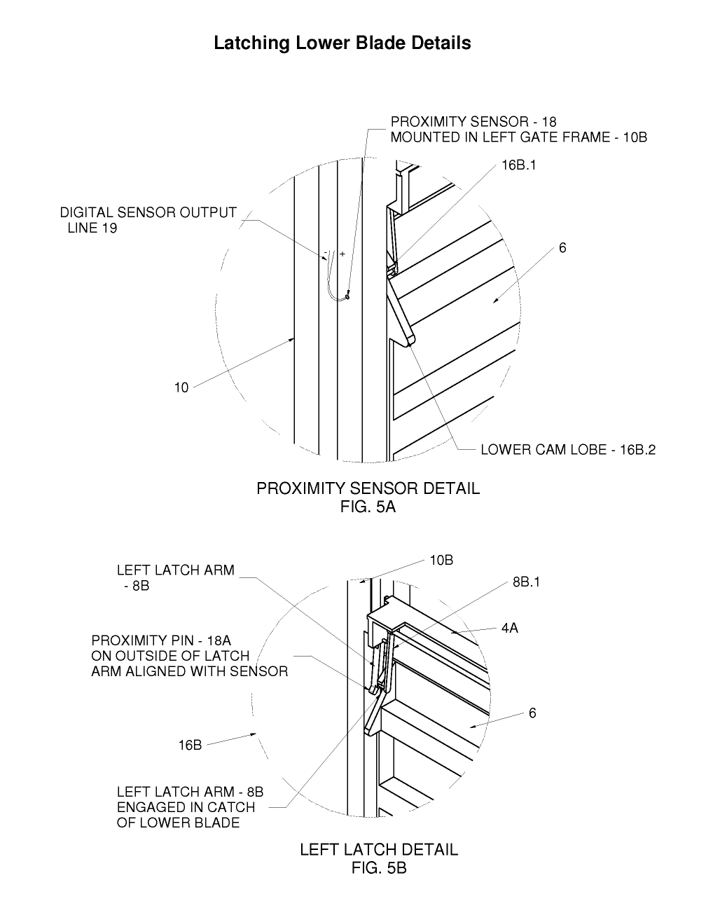

FIG. 1D is a detailed partial view of the gate frame 10 in combination with a lower blade upper area 6D in the unlatched condition of FIG. 1A. As shown in FIG. 4C, a right latch assembly 16A of the lower blade 6, as shown in FIG. 6B, is shaped to enable alternate latching and releasing of the latch rod 8. The right catch 6B formed by the right upper cam lobe 16A.1 captures the right latch arm 8A of the latch rod 8 as the upper blade 4 is lowered with the latch rod 8 in the armed condition. The right catch 6B is the lower edge of the right upper cam lobe 16A.1. When the latch rod 8 is in the armed condition and is lowered into the right catch 6B, the right latch arm return spring 8A.1 pulls the latch rod 8 into the right catch 6B and against the lower blade 6 to place the latch rod 8 into a coupling position, whereby the upper blade 4 is entrained with the lower blade 6 in vertical upward movement.

In addition, when the latch rod 8 is in the armed condition and the left latch arm 8B is lowered into the left catch 6C of a left catch assembly 16B, by turning the lift stem 12 and driving the upper blade 4 downward, the left latch arm return spring 8B.1 pulls the left latch arm 8B into the left catch 6C of the lower blade 6 and against the lower blade 6 to thereby pull the latch rod 8 into the coupling position to entrain the lower blade 6 with the upper blade 4. The left catch 6C is the lower edge of a left upper cam lobe 16B.1 of the left catch assembly 16B.

From the coupling position, the lift stem 12 may further drive the upper blade 6 to a lower position relative to the lower blade 6 and to drive both the right latch arm 8A below the right catch 6B and the left latch arm 8B below the left catch 6C, and still further downward respectively over a lower right cam lobe 16A.2 and, as shown in FIG. 5A, a lower left cam lobe 16B.2, whereby the latch rod 8 is transitioned from the armed condition and into a release position. In the release position, the latch rod 8 clears the upper right cam lobe 16A.1 as the upper gate blade 6 rises vertically upwards and away the upper left cam lobe 16B.1 of the lower blade 6; with the latch rod 8 in the release position the upper blade 4 is then movable upward vertically without causing a coupling of the latch rod 8 with either of lower blade lower cam lobes 16A.2 & 16B.2 or lower blade upper cam lobes 16A.1 &16B.1, whereby the lower blade 6 remains in the lowest vertical position within the gate frame 10 as the upper blade 4 freely moves vertically up or down within the gate frame 10, and until the latch rod 8 is forced from the released position and into the armed state by interference of the left reset plate 10E with the left latch arm 8B.

Referring now generally to Figures and particularly to FIG. 2A through FIG. 2C, FIG. 2A is a front view the split gate 2, wherein the upper blade 4 and the lower blade 6 are not entrained and the right latch arm 8A and the left latch arm 8B are in the armed state. Horizontal movement of the upper blade 4 along either the mutually orthogonal X-axis or Z-axis is constrained by the gate frame 10, as indicated in FIG. 2B and FIG. 6C. It is understood that the X-axis and the Z-axis define a horizontal plane, and that the vertical Z-axis is orthogonal to both the Z-axis and the Y-axis.

FIG. 2B is a detailed side view of the right latch arm 8A in the armed state and the wherein the right latch arm 8A is not engaged with the right catch 6B of the lower blade 6. The right latch extension spring 8A.1 maintains the right latch arm 8A in the armed state and provides tension force that pulls the right latch arm 8A to make contact with the lower blade 6 as the upper blade 6 is lowered vertically within the gate frame 10 by rotation of the lift stem 12.

FIG. 2C is, in comparison with the side view of FIG. 2B, a reverse view of the right latch 8A, wherein the right latch extension spring 8A.1 is exposed in a centered state and shown to be maintaining the right latch arm 8A in the armed state.

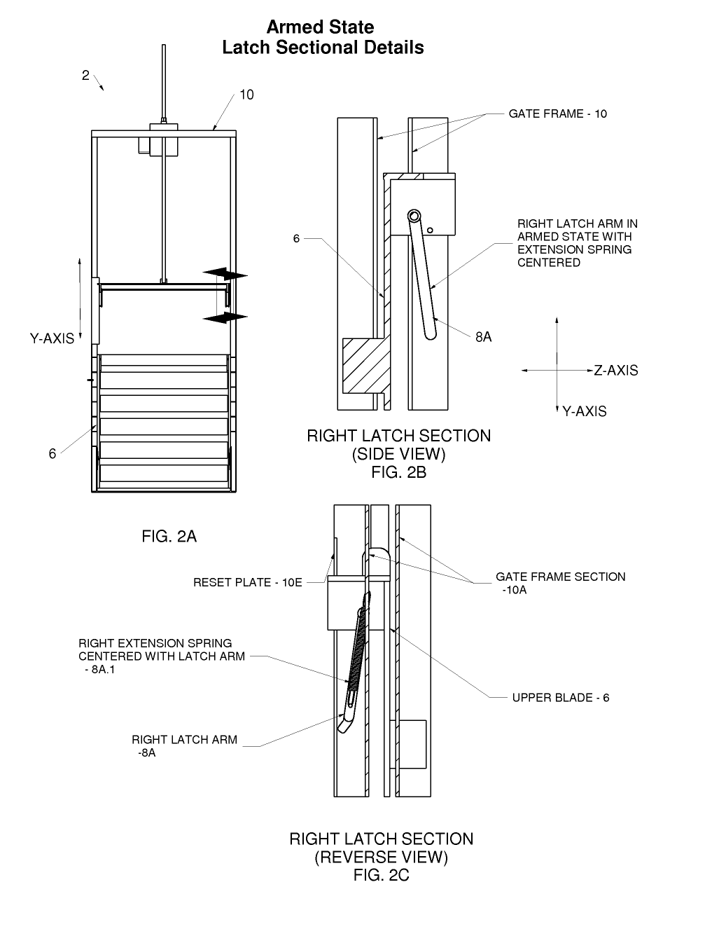

Referring now generally to Figures and particularly to FIG. 3A and FIG. 3B, FIG. 3A is an upper left isometric view of the split gate 2 in a latched condition, wherein the upper blade 4 and the lower blade 6 are entrained by the engagement of the latch rod 8 of with the left catch 6C and the right catch 6B of the lower blade 6. The lower blade 6 is shown in FIG. 3A as positioned at a lowest vertical position permitted by the bottom bar 10D of the gate frame 10. A proximity sensor location 10F of the gate frame 10 is indicated in FIG. 3A, as is further detailed in FIG. 5A.

FIG. 3B is an upper right isometric view of the split gate 2 in the latched condition and in the same lowest vertical position as shown in FIG. 3A, wherein the upper blade 4 and the lower blade 6 are entrained and the lower blade 6 is positioned at a lowest vertical position within the gate frame 10. A left latch arm location is indicated, as is further detailed in FIG. 5B.

Referring now generally to Figures and particularly to FIG. 4A through 4C, FIG. 4A is an upper left isometric view of the upper blade 4 and the lower blade 6 in the latched condition and wherein the upper blade 4 is positioned by rotation of the lift stem 12 in engagement with the upper blade 4 into a mid-range vertical position within the gate frame 10.

FIG. 4B is an upper right isometric view of the upper blade 4 and the lower blade 6 of FIG. 1A in the latched, entrained and coupled condition by engagement of the rod 8 with the lower blade catches 6B and 6C, and wherein the upper blade 4 is positioned by rotation of the lift stem 12 in engagement with the upper blade 4 into a mid-range vertical position within the gate frame 10.

Frame 4C is a detailed view of the right latch assembly 16A wherein the right latch arm 8A is in the armed state and is engaged with the right catch 6B of the lower blade 6, causing the lower blade 6 to move vertically in entrainment with the upper blade 4.

Referring now generally to Figures and particularly to FIG. 5A and FIG. 5B, FIG. 5A is a detailed view of an installation of an electronic proximity sensor 18 as positioned within the left bar 10B of the gate frame 10, and shown at a moment when the moveable lower blade 6 is positioned to be sensed by the proximity sensor 18. A digital sensor output line 19 transfers sensing signals emitted by the proximity sensor 18 to a logic module (not shown).

FIG. 5B is a detailed view of the left latch assembly 16B of the gate assembly of FIG. 1A and showing a proximity detection pin 18A of the proximity sensor 18 of FIG. 5A and further showing the left latch arm 8B engaged with the left catch 6C of the lower blade 6.

Referring now generally to Figures and particularly to FIG. 6A and FIG. 6B, FIG. 6A is a front view of the lower blade 6 entrained with the upper blade 4 and wherein the lower blade 6 is positioned at a lowest vertical position permitted by the gate frame 10.

FIG. 6B is detailed sectional side view of the right latch assembly 16A of the split gate 2 of FIG. 1A wherein the right latch arm 8A of the latch rod 8 is engaged with the right catch 6B of the lower blade 6. The right latch extension return spring 8A.1 provides tension force that drives the right latch arm 8A into the lower blade right catch 6B and toward the lower blade 6. A right latch pin 8A.2 limits the upward rotation of the right latch arm 8A to maintain the right latch arm 8A in the release position when the right latch arm 8A is forced into the release position.

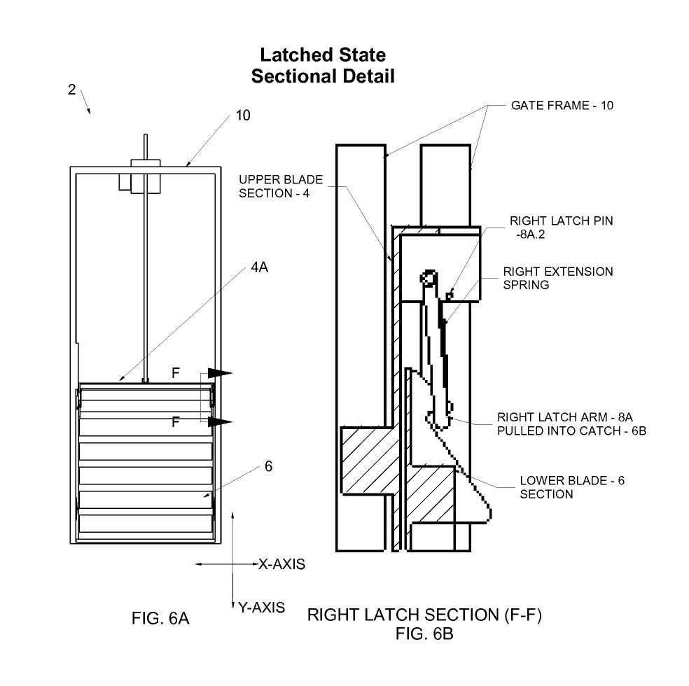

Referring now generally to Figures and particularly to FIG. 7A and FIG. 7B, FIG. 7A is a detailed isometric view of the upper blade 4 and the lower blade 6 wherein the right latch arm 8A is in the released state and is constrained from further upward rotation by the right latch pin 8A.2.

FIG. 7B is a detailed side view of the upper blade 4 and the lower blade 6 wherein the right latch arm 8A is placed into the released state by downward motion of the upper blade 4, wherein the lower blade 6 is at a lowest vertical position within the frame 10 and the upper blade 4 is driven yet further downward, whereby the lower right cam lobe 16A.2 of the lower blade 6 forces the right latch arm 8A from the armed state and into the release position and thereby against the right latch pin 8A.2.

Referring now generally to Figures and particularly to FIG. 8A through FIG. 8D, FIG. 8A is an upper left isometric view of the split gate 2 in an unlatched condition, and wherein the left latch arm 8B is forced from a release position and returned to the armed state, and indicating the left side detail of FIG. 8C.

FIG. 8B is an upper right isometric view of a split gate 2 in an unlatched condition, and wherein the right latch arm 8A is forced from a release position and returned to the armed state, and indicating a right side detail of FIG. 8D.

FIG. 8C is a left side isometric detail view of the split gate 2 in the condition of FIG. 8A. The left latch arm 8B is reset from the release position and into the armed state as forced by the left reset plate 10E of the gate frame 10 when the lower blade 6 is uncoupled with the upper blade 4 and the latch rod 8 is driven vertically upward within the gate frame 10 and against the left reset plate 10E.

FIG. 8D is a detailed right side isometric view of the split gate 2 in the condition of FIG. 8A. The right latch return spring 8A.1 pulls and holds the right latch arm 8A against the right frame pin 8A.2 when the right latch arm 8A is in the release position. The right frame pin 8A.2 thus limits the upward rotation of the right latch arm 8A.

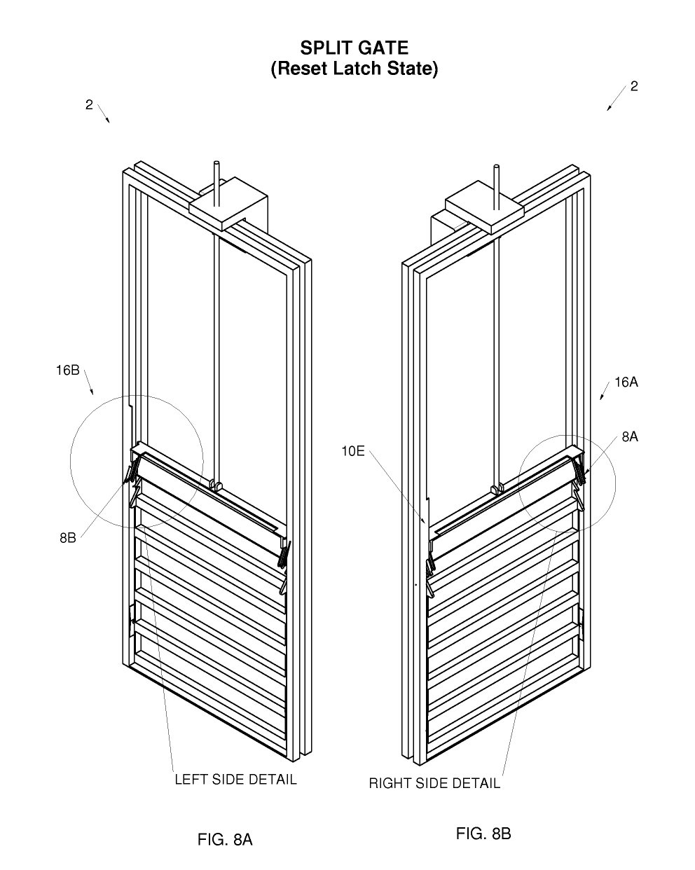

Referring now generally to Figures and particularly to FIG. 9A through FIG. 9C, FIG. 9A is a side view of the split gate 2 wherein the latch rod 8 is reset into the armed state, and FIG. 9B is a front view of the split gate 2 wherein the latch rod 8 is reset into the armed state.

FIG. 9C is a side view of a detail of the split gate 2 of FIG. 1A, wherein the left latch arm 8B is shown to forced from the release position and into the armed state by contact against the left reset plate 10E of the gate frame 10 as the upper blade 4 is driven vertically upward and against the left reset plate 14E.

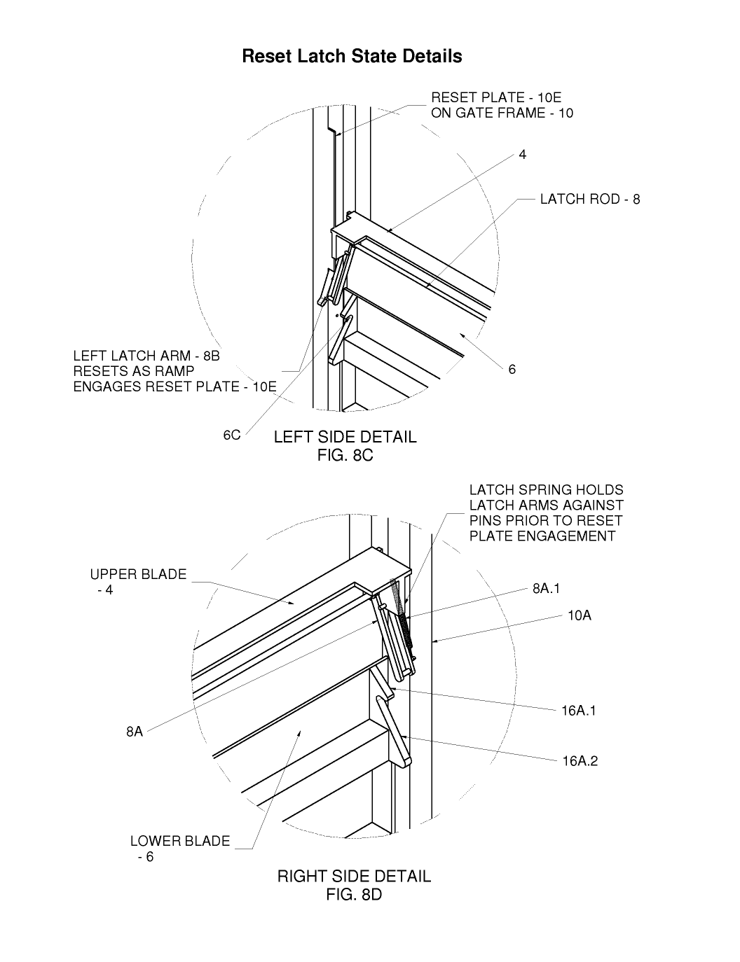

Referring now generally to Figures and particularly to FIG. 10A and FIG. 10B, FIG. 10A is an upper right isometric view of the split gate 2 wherein a detail view of FIG. 10B is indicated.

FIG. 10B is an isometric view of a detail of the lift stem 12 and a lift nut sprocket assembly 20 of the split gate 2 of FIG. 1A. A lower end 12A of the threaded lift stem 12 extends through the gate frame 10 and is rotatably coupled with the top edge 4A of the upper blade 4. A threaded lift nut 20A of the lift nut sprocket assembly 20 engages with the lift stem 12 and drives the lift stem 12 alternately up or down as the motorized actuator 14 causes the lift nut 20A to alternately rotate clock-wise or counter clockwise relative to a plane horizontal to the length of the lift stem 12. The lift nut 20A is fixedly mounted on a lift sprocket 20. The lift stem 12 extends through and is rotatable within both the lift nut 20A and the lift sprocket 20B. The lift sprocket 20B is rotatably coupled with the gate frame 10, wherein the lift nut 20A and the lift sprocket 20B are free to rotate within the horizontal plane as driven by a drive chain 20C. The drive chain 20C couples a motor drive sprocket 20D of the motorized actuator 14 and enables the motor drive sprocket 20D to alternately clock-wise or counter-wise rotate the lift nut 20A and the lift sprocket 20B in unison.

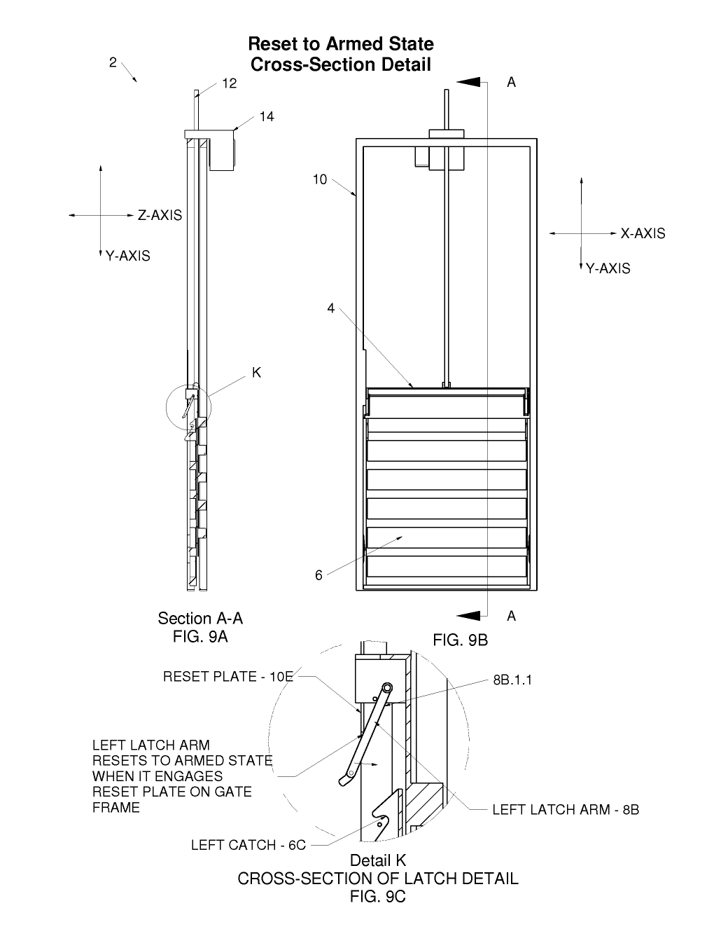

Referring now generally to Figures and particularly to FIG. 11A and FIG. 11B, FIG. 11A is an upper right isometric view of an alternate split gate 22 having a primary lead screw 24 and a secondary lead screw 26, i.e., threaded primary lift stem 24 and threaded secondary lift stem 26, engaging with the upper blade 4 and wherein the detail view of FIG. 11B is indicated.

FIG. 11B is an isometric view of a detail of the pair of lift stems 24 & 26 and actuator 14 of the alternate split gate 22. The primary lift stem 24 is rotatably coupled at a primary stem lower end 24A to the upper blade 4. A vertical actuation output sprocket 14B of the motor drive actuator 14 is coupled to a primary gear 28 of a primary gear lift 30 by the drive chain 20C. The primary lift gear 30 is rotatably coupled to the primary lift stem 24 and is adapted and positioned to drive the threaded primary lift stem 24 in a clock-wise or a counter clock-wise direction and to thereby raise or lower the primary lift stem 24.

The secondary lift stem 26 is additionally rotatably coupled at a second stem lower end 26A to the upper blade 4. A drive shaft 32 couples the primary lift gear 30 with a secondary lift gear 34. The drive shaft 32 transfers mechanical torque from the primary lift gear 30 and to the secondary lift gear 34. The secondary lift gear 34 engages with the threaded secondary lift stem 26. The secondary lift gear 34 is adapted to alternately drive the secondary lift stem 26 in a clock-wise or a counter clock-wise and to thereby raise or lower the secondary lift stem 26. The drive shaft 32 and the secondary lift gear 34 are adapted to cause the secondary lift stem 26 to raise the or lower the upper blade 6 in unison with the direction of force as applied by the primary lift stem 24 to the upper blade 4.

One or more elements 4 through 34 of the split gate 2 may be or comprise metal, such as aluminum, stainless steel, galvanized steel or other suitable metal, metal alloy, synthetic or organic materials known in the art, in whole or in part, and in singularity or in combination. In particular, the frame 10, upper blade 4, lower blade 6, rod 8, latch arm springs 8A.a & 8B.1 and/or latch assemblies 16A & 16B may be or comprise metal, such as aluminum, stainless steel, galvanized steel or other suitable metal, metal alloy, synthetic or organic materials known in the art, in whole or in part, and in singularity or in combination.

The foregoing disclosures and statements are illustrative only of the present invention, and are not intended to limit or define the scope of the present invention. The above description is intended to be illustrative, and not restrictive. Although the examples given include many specificities, they are intended as illustrative of only certain possible applications of the present invention. The examples given should only be interpreted as illustrations of some of the applications of the present invention, and the full scope of the Present Invention should be determined by the appended claims and their legal equivalents. Those skilled in the art will appreciate that various adaptations and modifications of the just-described applications can be configured without departing from the scope and spirit of the present invention. Therefore, it is to be understood that the present invention may be practiced other than as specifically described herein. The scope of the present invention as disclosed and claimed should, therefore, be determined with reference to the knowledge of one skilled in the art and in light of the disclosures presented above.

I claim:

1. An apparatus comprising:
a frame;
an upper blade, the upper blade slidably coupled with the frame and adapted to impede water flow, the upper blade having a lower edge and an upper edge, wherein the upper blade is positionable to permit water flow over the upper edge;
a lower blade, the lower blade slidably coupled with the frame and adapted to impede water flow; and
a selectable coupling module, the selectable coupling module adapted to enable the upper blade and the lower blade to selectively and alternatively be entrained and decoupled.

2. The apparatus of claim 1, wherein the frame is further adapted to position the upper blade completely above a water flow.

3. The apparatus of claim 1, wherein the frame is further adapted to position the lower blade completely above a water flow.

4. The apparatus of claim 3, wherein the frame is further adapted to position the upper blade completely above a water flow.

5. The apparatus of claim 1, further comprising a top threaded stem coupled with the upper blade, wherein rotating the top threaded stem causes the upper blade to either raise or lower.

6. The apparatus of claim 5, further comprising a motor coupled with the top threaded stem coupled with the lower blade, wherein the motor alternately drives the top threaded stem clockwise or counter-clockwise.

7. The apparatus of claim 1, wherein selectable coupling module is adapted to decouple the lower blade at a lowest vertical position of the lower blade.

8. The apparatus of claim 7, wherein the upper blade is adapted to decouple from the lower blade at a lowest vertical position of the upper blade.

9. The apparatus of claim 7, wherein the frame is further adapted to position the upper blade completely above a water flow.

10. The apparatus of claim 1, further comprising a top threaded stem coupled with the upper blade, wherein rotating the top threaded stem causes the upper blade to either raise or lower.

11. An apparatus comprising:
a frame,
an upper blade having a spring-loaded catch, the upper blade slidably coupled with the frame and adapted to impede water flow, the upper blade having an upper edge, wherein the upper blade is positionable to permit water flow over the upper edge;
a lower blade, the lower blade slidably coupled with the frame and adapted to impede water flow; and
the spring-loaded assembly having a first position and a second position, wherein the spring-loaded assembly couples the upper blade and the lower blade in the first position and the spring-loaded assembly decouples the upper blade and the lower blade in the second position.

12. The apparatus of claim 11, further comprising a threaded stem coupled with the upper blade, wherein the threaded stem alternately raises and lowers the upper blade when rotated alternately clockwise and counter-clockwise.

13. The apparatus of claim 12, further comprising a motor coupled with the top threaded stem coupled with the lower blade, wherein the motor alternately drives the top threaded stem alternately clockwise and counter-clockwise.

14. The apparatus of claim 11, further comprising a proximity sensor, the proximity sensor transmitting a signal indicating a relative position of the upper blade and the lower blade.

15. The apparatus of claim 11, wherein the lower blade further comprising a release feature, the release feature for driving the spring-loaded assembly from the first position and into the second position.

16. The apparatus of claim 11, wherein the frame further comprising a reset feature, the reset feature for driving the spring-loaded assembly from the second position and into the first position.

17. A method comprising:
a. installing an apparatus in an irrigation vessel, the apparatus including:
i. a frame;
ii. an upper blade, the upper blade slidably coupled with the frame and adapted to impede water flow, the upper blade having an upper edge, wherein the upper blade is positionable to permit water flow over the upper edge;
iii. a lower blade, the lower blade slidably coupled with the frame and adapted to impede water flow; and
iv. a selectable coupling module, the selectable coupling adapted to enable the upper blade and the lower blade to selectively and alternatively be entrained and decoupled;
b. coupling the upper blade with the lower blade; and
c. positioning the upper blade to position the lower blade to allow water flow below lower blade.

18. The method of claim 17, further comprising coupling a motorized actuator to the upper blade, whereby the motorized actuator is enabled to alternately raise and lower the upper blade.

19. The method of claim 18, further comprising disposing a first threaded lift stem between the motorized actuator and the upper blade, whereby the motorized actuator rotates the first threaded lift stem to alternately raise and lower the upper blade.

20. The method of claim 18, further comprising disposing a second threaded lift stem between the motorized actuator and the upper blade, whereby the motorized actuator rotates the second threaded lift stem in unison with rotating the first threaded lift stem to alternately raise and lower the upper blade.
